(19) United States
(12) Patent Application Publication
(10) Pub. No.: US 2019/0158015 A1
(43) Pub. Date: May 23, 2019

(54) APPARATUSES, SYSTEMS, AND METHODS FOR A DIRECT-ATTACHMENT SPACE FRAME

(71) Applicant: Quest Renewables, LLC, Atlanta, GA (US)

(72) Inventors: Joseph N. Goodman, Snowmass Village, CO (US); Beau Baldock, Atlanta, GA (US)

(21) Appl. No.: 16/191,181

(22) Filed: Nov. 14, 2018

Related U.S. Application Data
(60) Provisional application No. 62/585,854, filed on Nov. 14, 2017.
(60) Provisional application No. 62/585,863, filed on Nov. 14, 2017.
(60) Provisional application No. 62/585,846, filed on Nov. 14, 2017.
(60) Provisional application No. 62/585,857, filed on Nov. 14, 2017.

(51) Int. Cl. H02S 30/10; H02S 20/32

(52) U.S. Cl. CPC H02S 30/10; H02S 20/32

(57) ABSTRACT

Apparatuses, systems, and methods for a direct-attachment space frame comprises a PV module affixed to and supported by at least two of the chords of a space frame (e.g., a triangular configuration of two parallel top chords and one parallel bottom chord, wherein the top chords are connected to each other with transverse struts and to the bottom chord with web struts) to increase the structural integrity, decrease the part count, and increase the ease of construction of the array.

### CROSS REFERENCE TO RELATED APPLICATIONS

This application claims priority to, the benefit under 35 U.S.C. § 119 of, and incorporates by reference herein in their entireties: U.S. Provisional Patent Application No. 62/585,854, filed Nov. 14, 2017, and entitled “Apparatuses, Systems, and Methods for a Direct-Attachment Space Frame”; U.S. Provisional Patent Application No. 62/585,863, filed Nov. 14, 2017, and entitled “Apparatuses, Systems, and Methods for a Pyramidal Photovoltaic Array”; U.S. Provisional Patent Application No. 62/585,846, filed Nov. 14, 2017, and entitled “Apparatuses, Systems, and Methods for a Prefabricated Space Frame Building System”; and U.S. Provisional Patent Application No. 62/585,857, filed Nov. 14, 2017, and entitled “Apparatuses, Systems, and Methods for a Multi-Component Photovoltaic Module Receiver.”

### TECHNICAL FIELD

The present apparatuses, systems, and methods relate generally to photovoltaic arrays and, more particularly, to space frames for directly supporting photovoltaic modules.

### BACKGROUND

Currently, photovoltaic (“PV”) modules (e.g., “solar panels”) require structural support on at least two sides. In typical applications, this required structural support is achieved with either rails that are shared between two or more PV modules or individual support bases that each support a single PV module. Shared rails, however, are generally supported by columns that transfer loads via bending, which is structurally inefficient; support bases do not provide for optimal alignment between bases and do not effectively share loads between bases, both of which reduce structural and material efficiency. In another application, space frames are used in PV arrays such that a single, large space frame supports a set of secondary beams to which multiple PV modules are affixed. Space frames with secondary beams, however, have high part counts and rely on bending in the secondary beams, which result in a materially and structurally inefficient system.

Therefore, there is a long-felt but unresolved need for a PV module support system that is structurally and materially efficient.

### BRIEF SUMMARY OF THE DISCLOSURE

Briefly described, and according to one embodiment, aspects of the present disclosure generally relate to apparatuses, systems, and methods for a direct-attachment space frame that structurally supports multiple PV modules on one transportable platform without secondary beams.

In various embodiments, a direct-attachment space frame comprises a PV module affixed to and supported by at least two of the chords of a space frame (e.g., a triangular configuration of two parallel top chords and one parallel bottom chord, wherein the top chords are connected to each other with transverse struts and to the bottom chord with web struts) to increase the structural integrity, decrease the part count, and increase the ease of construction of the array. Generally, multiple direct attachment solar module space frames may be coupled together to form a larger array comprising two or more parallel rows of PV modules to further increase the structural and material efficiency of the array. Two direct attachment solar module space frames, in various embodiments, may be paired together such that the PV modules are positioned at an angle to increase direct solar irradiance on the PV modules, to decrease wind loads on the array, and to increase self-cleaning of the PV modules during rain events. In various embodiments, the direct-attachment space frame may comprise integrated tracking hardware for the purpose of moving the PV modules to track the sun to increase the output of the same.

In one embodiment, a direct-attachment photovoltaic system, comprising: a space frame comprising: two parallel top chords affixed via a plurality of transverse struts; and a bottom chord that is parallel to the two parallel top chords and affixed to the two parallel top chords via a plurality of web struts; and at least one photovoltaic module affixed directly to the two parallel top chords via one or more fasteners.

In one embodiment, a method of installing a direct-attachment photovoltaic system, comprising the steps of: assembling a space frame comprising: two parallel top chords affixed via a plurality of transverse struts; and a bottom chord that is parallel to the two parallel top chords and affixed to the two parallel top chords via a plurality of web struts; and affixing at least one photovoltaic module directly to the two parallel top chords via one or more fasteners.

According to one aspect of the present disclosure, the system, further comprising: a second space frame comprising: two second parallel top chords affixed via a plurality of second transverse struts; and a second bottom chord that is parallel to the two second parallel top chords and affixed to the two second parallel top chords via a plurality of second web struts; and at least one second photovoltaic module affixed directly to the two second parallel top chords via one or more second fasteners. Furthermore, the system, wherein one of the two parallel top chords comprises one of the two second parallel top chords. Moreover, the system, further comprising a plurality of chord coupling struts affixed between the bottom chord and the second bottom chord. Further, the system, wherein the at least one photovoltaic module is oriented in the same plane as the at least one second photovoltaic module. Additionally, the system, wherein the at least one photovoltaic module is oriented at an angle to the at least one second photovoltaic module. Also, the system, wherein the at least one photovoltaic module is oriented parallel to the at least one second photovoltaic module.

According to one aspect of the present disclosure, the system, further comprising integrated tracking hardware to adjust the orientation of the at least one photovoltaic module and/or the at least one second photovoltaic module. Furthermore, the system, wherein each of the two parallel top chords further comprises a channel into which the at least one photovoltaic module is seated. Moreover, the system, wherein the at least one photovoltaic module further comprises at least two photovoltaic modules. Further, the system, wherein the fastener comprises a clamp, insert, bolt, adhesive, or pin connection.

According to one aspect of the present disclosure, the method, further comprising the steps of: assembling a second space frame comprising: two second parallel top chords affixed via a plurality of second transverse struts; and a second bottom chord that is parallel to the two second parallel top chords and affixed to the two second parallel top chords via a plurality of second web struts; affixing a plurality of chord coupling struts between the bottom chord and the second bottom chord; and affixing at least one second photovoltaic module directly to the two second parallel top chords via one or more second fasteners. Additionally, the method, wherein one of the two parallel top chords comprises one of the two second parallel top chords. Also, the method, wherein the at least one photovoltaic module is oriented in the same plane as the at least one second photovoltaic module. Furthermore, the method, wherein the at least one photovoltaic module is oriented at an angle to the at least one second photovoltaic module. Moreover, the method, wherein the at least one photovoltaic module is oriented parallel to the at least one second photovoltaic module. Further, the method, further comprising the step of installing integrated tracking hardware to adjust the orientation of the at least one photovoltaic module and/or the at least one second photovoltaic module.

According to one aspect of the present disclosure, the method, wherein each of the two parallel top chords further comprises a channel into which the at least one photovoltaic module is seated. Additionally, the method, wherein the at least one photovoltaic module further comprises at least two photovoltaic modules.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 (consisting of FIGS. 1A and 1B) illustrates an exemplary direct-attachment space frame according to one embodiment of the present disclosure.

FIG. 2 illustrates exemplary coupled direct-attachment space frames according to one embodiment of the present disclosure.

FIG. 3 illustrates an exemplary tilted direct-attachment space frame according to one embodiment of the present disclosure.

FIG. 4 illustrates an exemplary direct-attachment space frame with integrated tracking hardware according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to apparatuses, systems, and methods for apparatuses, systems, and methods for a direct-attachment space frame that structurally supports multiple PV modules on one transportable platform without secondary beams.

In various embodiments, a direct-attachment space frame comprises a PV module affixed to and supported by at least two of the chords of a space frame (e.g., a triangular configuration of two parallel top chords and one parallel bottom chord, wherein the top chords are connected to each other with transverse struts and to the bottom chord with web struts) to increase the structural integrity, decrease the part count, and increase the ease of construction of the array. Generally, multiple direct attachment solar module space frames may be coupled together to form a larger array comprising two or more parallel rows of PV modules to further increase the structural and material efficiency of the array. Two direct attachment solar module space frames, in various embodiments, may be paired together such that the PV modules are positioned at an angle to increase direct solar irradiance on the PV modules, to decrease wind loads on the array, and to increase self-cleaning of the PV modules during rain events. In various embodiments, the direct-attachment space frame may comprise integrated tracking hardware for the purpose of moving the PV modules to track the sun to increase the output of the same.

### Exemplary Embodiments

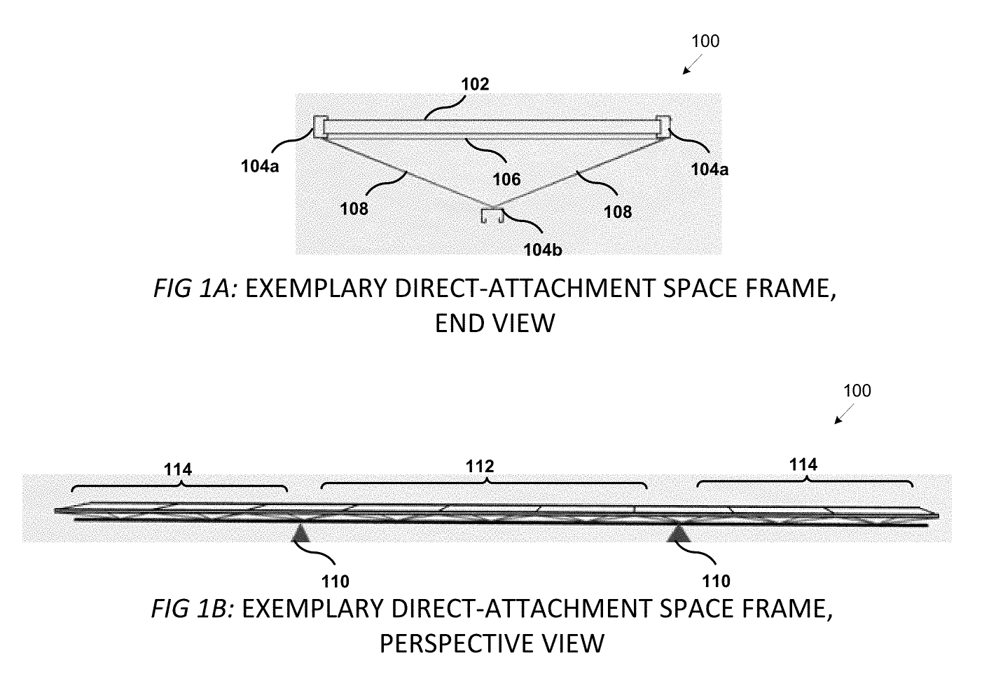

Referring now to the figures, for the purposes of example and explanation of the fundamental processes and components of the disclosed apparatuses, systems, and methods, reference is made to FIG. 1 (consisting of FIGS. 1A and 1B, an end view and perspective view, respectively), which illustrates an exemplary, high-level overview of one embodiment of an exemplary direct-attachment space frame 100. As will be understood and appreciated, the exemplary direct-attachment space frame 100 shown in FIG. 1 represents merely one approach or embodiment of the present disclosure, and other aspects are used according to various embodiments of the present disclosure.

In various embodiments, the exemplary direct-attachment space frame 100 comprises a PV module 102 affixed to and supported by at least two of the chords 104 of a space frame. As will occur to one having ordinary skill in the art, a space frame, generally, comprises a triangular configuration of two parallel top chords (e.g., top chords 104a, extending into the page of FIG. 1A and extending along the length of the exemplary direct-attachment space frame 100 in FIG. 1B) and one parallel bottom chord (e.g., bottom chord 104b, extending into the page of FIG. 1A and extending along the length of the exemplary direct-attachment space frame 100 in FIG. 1B), wherein the top chords are connected to each other with transverse struts (e.g., transverse strut 106) and to the lower chord with web struts (e.g., web struts 108) that are attached to the chords via pins or other appropriate fasteners. In one embodiment, the PV module 102 also attaches to the transverse struts 106 for additional support. The PV modules 102, in various embodiments, may be affixed to the top chords 104a via a clamp, an insert, a bolt, adhesive, or any other fastening means. In one embodiment, the top chords 104a comprise, at predetermined positions along their lengths, fasteners to hold the PV modules 102. In one embodiment, the top chords 104a comprise a channel running along their length in which the PV modules 102 are seated.

The exemplary direct-attachment space frame 100, in various embodiments, may be supported by one or more bases 110 at predetermined points along the exemplary direct-attachment space frame 100, depending on its particular structural geometry. Generally, the structural geometry of the exemplary direct-attachment space frame 100 enables expansive multi-PV module cantilevers 114 past bases 110 and simple multi-PV module spans 112 between bases 110. This structural geometry further enables, in various embodiments, the exemplary direct-attachment space frame 100 to be preassembled in pieces (e.g., a length of the exemplary direct-attachment space frame 100 comprising PV modules 102 attached to the top chords 104a, which are attached to the bottom chord 104b) and a single piece of the exemplary direct-attachment space frame 100 to be lifted from an assembly location with just two lifting points (e.g., those points that will be supported by bases 110) and moved to a final installation location or even one of many temporary locations (e.g., for storage, shipping, installation, etc.).

When a load is applied to the exemplary direct-attachment space frame 100 (e.g., gravity, wind, snow, etc.), in various embodiments, the geometric separation between the top chords 104a and the bottom chord 104b, and their stiffness, resulting in material and structural efficiencies that enable load transfer with stresses inversely proportionally to the separation distance between the chords. In one non-limiting example, with top chord to bottom chord vertical distance of ⅓ the top chord separation distance (e.g., 3-7 ft, 5-10 ft, etc.), the individual chord stresses are reduced by at least 50% as compared to a typical monolithic beam with 0.25-0.5 ft of depth.

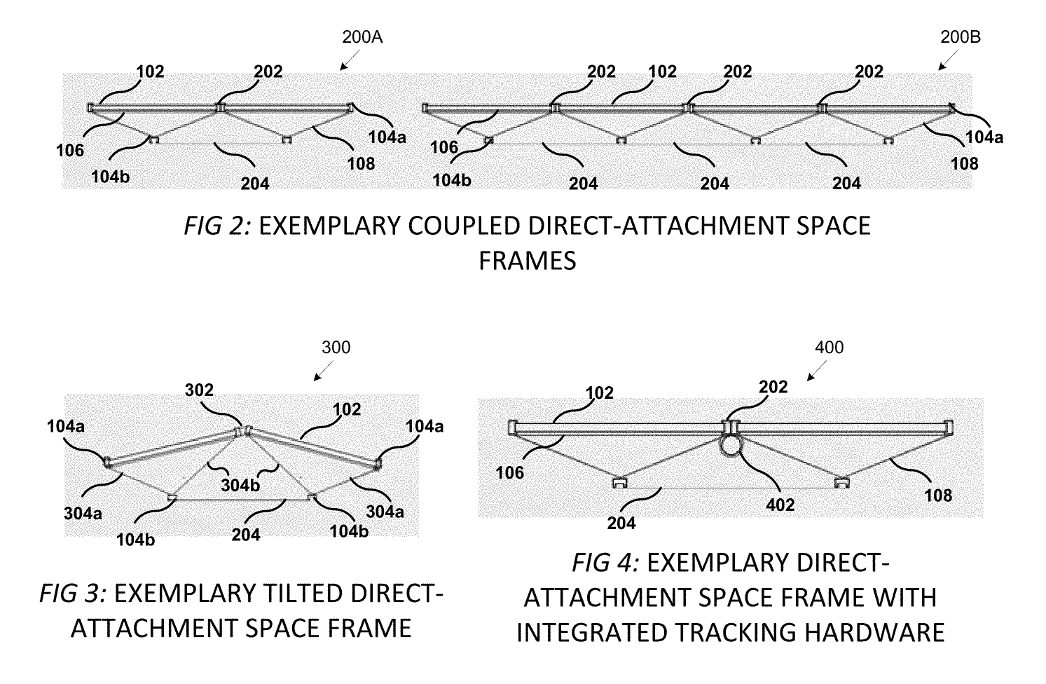

Referring now to FIG. 2, exemplary coupled direct-attachment space frames 200A (two PV modules 102) and 200B (four PV modules 102) are shown according to one embodiment of the present disclosure. Generally, multiple direct attachment solar module space frames may be coupled together into coupled direct-attachment space frames 200A and 200B to form a larger array comprising two or more parallel rows of PV modules 102 to further increase the structural and material efficiency of the coupled direct-attachment space frames 200A and 200B. This disclosure places no limitations on the number of parallel rows of PV modules 102 that may comprise a coupled direct-attachment space frame 200A or 200B.

In various embodiments, the coupled direct-attachment space frames 200A and 200B comprise pairs of direct attachment solar module space frames that share a top chord coupling strut 202 in place of one top chord 104a (generally, an interior direct attachment solar module space frame within a coupled direct-attachment space frame 200B with more than two parallel rows of PV modules 102 comprises two top chord coupling struts 202 in place of both of its top chords 104a). In various embodiments, the bottom chords 104b of the pairs of direct attachment solar module space frames are joined by a bottom chord coupling strut 204 attached between their two bottom chords 104b. Generally, the chord coupling struts 202 and 204 may comprise a stationary connection that prevents rotation or a hinged connection that allows for a subset of coupled direct-attachment space frames 200A or 200B to rotate with respect to other for the purpose of folding upon one another.

Now referring to FIG. 3, an exemplary tilted direct-attachment space frame 300 is shown according to one embodiment of the present disclosure. Generally, two direct attachment solar module space frames may be paired together with a bottom chord coupling strut 204 and (optionally) a tilted top chord coupling strut 202 and comprise asymmetrical struts 304a and 304b (e.g., struts of different lengths to achieve the desired angle) such that the PV modules 102 are positioned at an angle to increase direct solar irradiance, to decrease wind loads, and to increase self-cleaning during rain events. In various embodiments, the tilted direct-attachment space frame 300 the PV modules 102 may be oriented at the same angle (e.g., not shown in FIG. 3, using just a bottom chord coupling strut 204 and no tilted top chord coupling strut 202) or at different angles (e.g., shown in FIG. 3, using both a bottom chord coupling strut 204 and a tilted top chord coupling strut 202 shared by the direct attachment solar module space frames). Generally, this disclosure places no limitations on the possible orientations of the PV modules 102.

Referring now to FIG. 4, an exemplary direct-attachment space frame 400 with integrated tracking hardware 402 is shown according to one embodiment of the present disclosure. In various embodiments, the exemplary direct-attachment space frame 400 may be rotated for the purpose of tracking the sun to increase the output of the PV modules 102 attached thereto. In one embodiment, the integrated tracking hardware 402 comprises a rotational drive shaft and bearing. In one embodiment, the integrated tracking hardware 402 comprises a rotational torque tube and bearing. Generally, this disclosure places no limitations on the type of integrated tracking hardware 402.

In various embodiments, the integrated tracking hardware 402 is integrated into the exemplary direct-attachment space frame 400 at the top chord coupling strut 202 just below the PV modules 102, which transfers rotational forces into strut tension and compression and requires only low torque to move the PV modules 102 due to being located at the center of mass of the exemplary direct-attachment space frame 400.

The foregoing description of the exemplary embodiments has been presented only for the purposes of illustration and description and is not intended to be exhaustive or to limit the inventions to the precise forms disclosed. Many modifications and variations are possible in light of the above teaching. While various aspects have been described in the context of a preferred embodiment, additional aspects, features, and methodologies of the claimed inventions will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

What is claimed is:

1. A direct-attachment photovoltaic system, comprising:
a space frame comprising:
two parallel top chords affixed via a plurality of transverse struts; and
a bottom chord that is parallel to the two parallel top chords and affixed to the two parallel top chords via a plurality of web struts; and
at least one photovoltaic module affixed directly to the two parallel top chords via one or more fasteners.

2. The system of claim 1, further comprising:
a second space frame comprising:
two second parallel top chords affixed via a plurality of second transverse struts; and
a second bottom chord that is parallel to the two second parallel top chords and affixed to the two second parallel top chords via a plurality of second web struts; and
at least one second photovoltaic module affixed directly to the two second parallel top chords via one or more second fasteners.

3. The system of claim 2, wherein one of the two parallel top chords comprises one of the two second parallel top chords.

4. The system of claim 3, further comprising a plurality of chord coupling struts affixed between the bottom chord and the second bottom chord.

5. The system of claim 4, wherein the at least one photovoltaic module is oriented in the same plane as the at least one second photovoltaic module.

6. The system of claim 4, wherein the at least one photovoltaic module is oriented at an angle to the at least one second photovoltaic module.

7. The system of claim 4, wherein the at least one photovoltaic module is oriented parallel to the at least one second photovoltaic module.

8. The system of claim 4, further comprising integrated tracking hardware to adjust the orientation of the at least one photovoltaic module and/or the at least one second photovoltaic module.

9. The system of claim 1, wherein each of the two parallel top chords further comprises a channel into which the at least one photovoltaic module is seated.

10. The system of claim 1, wherein the at least one photovoltaic module further comprises at least two photovoltaic modules.

11. The system of claim 1, wherein the fastener comprises a clamp, insert, bolt, adhesive, or pin connection.

12. A method of installing a direct-attachment photovoltaic system, comprising the steps of:
assembling a space frame comprising:
two parallel top chords affixed via a plurality of transverse struts; and
a bottom chord that is parallel to the two parallel top chords and affixed to the two parallel top chords via a plurality of web struts; and
affixing at least one photovoltaic module directly to the two parallel top chords via one or more fasteners.

13. The method of claim 12, further comprising the steps of:
assembling a second space frame comprising:
two second parallel top chords affixed via a plurality of second transverse struts; and
a second bottom chord that is parallel to the two second parallel top chords and affixed to the two second parallel top chords via a plurality of second web struts;
affixing a plurality of chord coupling struts between the bottom chord and the second bottom chord; and
affixing at least one second photovoltaic module directly to the two second parallel top chords via one or more second fasteners.

14. The method of claim 13, wherein one of the two parallel top chords comprises one of the two second parallel top chords.

15. The method of claim 14, wherein the at least one photovoltaic module is oriented in the same plane as the at least one second photovoltaic module.

16. The method of claim 14, wherein the at least one photovoltaic module is oriented at an angle to the at least one second photovoltaic module.

17. The method of claim 14, wherein the at least one photovoltaic module is oriented parallel to the at least one second photovoltaic module.

18. The method of claim 14, further comprising the step of installing integrated tracking hardware to adjust the orientation of the at least one photovoltaic module and/or the at least one second photovoltaic module.

19. The method of claim 12, wherein each of the two parallel top chords further comprises a channel into which the at least one photovoltaic module is seated.

20. The method of claim 12, wherein the at least one photovoltaic module further comprises at least two photovoltaic modules.
